(19) United States
(12) Patent Application Publication
(10) Pub. No.: US 2007/0047412 A1
(43) Pub. Date: Mar. 1, 2007

(54) JITTER MEASURING METHOD AND DEVICE THEREOF

(76) Inventors: Yuan-Chin Liu, Hsinchu City (TW); Chih-Ching Yu, Tao-Yuan Hsien (TW); Chih-Hsiung Chu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/420,765

(22) Filed: May 28, 2006

Related U.S. Application Data
(60) Provisional application No. 60/713,007, filed on Aug. 31, 2005.

(51) Int. Cl. G11B 27/36

(52) U.S. Cl. 369/53.34

(57) ABSTRACT

The present invention provides a jitter measuring device. The device includes an edge position measuring unit and a jitter calculation unit. The edge position measuring unit receives a serial digital signal and a reference clock and measures edge position for each transition of the serial digital signal according to the reference clock. The jitter calculation unit, which is coupled to the edge detection unit, calculates a first average value of a plurality of edge position values and then determines the jitter of the serial digital signal by calculating an average value of the differences between the first average value and the edge position values.

### CROSS REFERENCE TO RELATED APPLICATIONS

This application claims the benefit of U.S. Provisional Application No. 60/713,007, filed on Aug. 31, 2005 and entitled “On-line jitter calculation method and device”, the contents of which are incorporated herein by reference.

### BACKGROUND

The disclosure relates to an optical storage system, especially to a data-to-clock (DC) jitter measuring method and the corresponding device for precisely calculating the transition edge position of a serial digital signal according to a multi-phase signal and calculating the jitter correctly.

A jitter measuring device plays an important role in an optical storage system. The jitter measuring device measures the signal read from an optical disc, and generates a result to indicate the write quality. The optical storage system can then adjust the write power or write strategy according to the result such that an optimum condition for the optical storage system is set during the subsequent writing process.

One typical jitter measuring device utilizes analog signals for measuring the jitter. This kind of jitter measuring device converts each pulse width of the serial digital signals into an analog signal, and then filters the voltage of the analog signal. The filtered voltage variation represents the jitter value. However, this analog type jitter measuring device is not able to only measure jitter values of serial digital signals belonging to the same specific length. And the switching speed of the used switches may greatly influence the measurement result, and the switches with a high switching speed cannot be easily implemented. Furthermore, the circuitry layout of this analog type jitter measuring device consumes a lot of circuitry layout area.

A U.S. Pat. No. 6,829,295 discloses a method for measuring a data-to-data (DD) jitter of an RF signal read from an optical disc, which only calculates the signal length variation. A U.S. patent application publication No. 2004/0136301 discloses an optical recording system with a built-in jitter and a method for measuring the edge position of an RF signal read from an optical disc. However it is necessary to provide the high resolution with more delayed signal groups, and it does not mention how to calculate the DC jitter.

### SUMMARY

One objective is therefore to provide a DC jitter measuring method and its corresponding device capable of precisely calculating the transition edge position of a serial digital signal according to a multi-phase signal and calculating the jitter correctly.

According to an embodiment of the disclosure, a DC jitter measuring device is disclosed. The jitter measuring device comprises a rough edge position measuring unit, a signal delay module, an edge detection unit, an edge position integration unit, and a jitter calculation unit. The rough edge position measuring unit receives the serial digital signal and a reference clock and generates a rough edge position for each transition of the serial digital signal. The signal delay module receives the serial digital signal and the reference clock having a period of t, and delays the serial digital signal to generate a set of N delay signals. A k^{th} delay signal of the N delay signals has a delay time of k*t/N with respect to the serial digital signal. The edge detection unit is coupled to the signal delay module and generates a fine edge position value according to the set of N delay signals and the reference clock. The edge position integration unit receives the rough edge position and the fine edge position, and computes an edge position for each transition of the serial digital signal. The jitter calculation unit is coupled to the edge position integration unit. The jitter calculation unit calculates a first average value of a plurality of edge position values and determines the jitter of the serial digital signal by calculating an average value of the differences between the first average value and the edge position values.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a part of an optical storage system including a DC jitter measuring device.

FIG. 2 shows a block diagram of the DC jitter measuring device according to a first embodiment of the present disclosure.

FIG. 3 is a timing diagram of the jitter measuring device shown in FIG. 2.

FIG. 4 shows a look-up table for mapping a phase latch value into a decode fine edge position value.

FIG. 5 shows a distribution of the edge position values.

FIG. 6 shows a shifted distribution of the edge position values.

FIG. 7 is the flow chart of the shift mechanism of the first embodiment.

FIG. 8 is the flow chart of the shift mechanism of the second embodiment.

FIG. 9 shows a chart of statistically classified edge position values.

FIG. 10 shows a block diagram of the DC jitter measuring device according to a second embodiment of the present disclosure.

FIG. 11 is a timing diagram of the jitter measuring device shown in FIG. 10.

### DETAILED DESCRIPTION

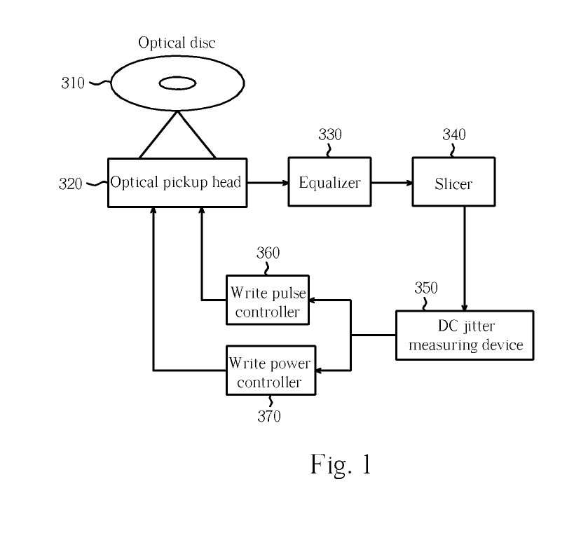

Please refer to FIG. 1. FIG. 1 shows a part of an optical storage system including a DC jitter measuring device. The optical pickup head 320 reads RF signals from the optical disc 310, and then the RF signals are processed by the equalizer 330. After being processed by the slicer 340, the RF signals turn into serial digital signals. The data-to-clock (DC) jitter measuring device 350 measures jitters of the serial digital signals, and then the write pulse controller 360 and the write power controller 370 can adjust the write strategy and write power according to the jitters of the serial digital signals.

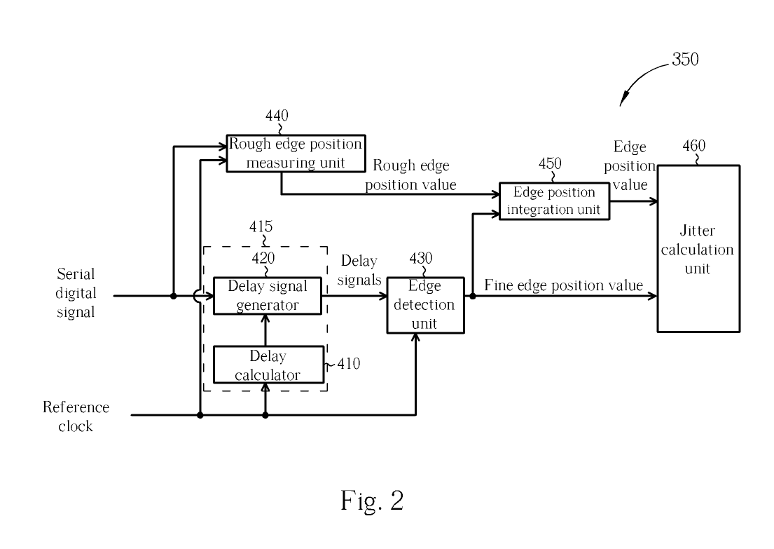

Please refer to FIG. 2. FIG. 2 shows a block diagram of the DC jitter measuring device 350 according to a first embodiment of the present invention. It includes a signal delay module 415 having a delay calculator 410 and a delay signal generator 420, an edge detection unit 430, a rough edge position measuring unit 440, an edge position integration unit 450, and a jitter calculation unit 460. The rough edge position measuring unit 440 directly measures the rough edge position value for each transition edge of the serial digital signal according to the reference clock. The delay calculator 410 receives a reference clock and generates a phase delay equivalent number, which will later be utilized by a delay signal generator 420, according to a fraction of the period t of the reference clock. For example, if a delay time unit of t/8 is required in the DC jitter measuring device 350, the delay calculator 410 will generate a phase delay equivalent number that determines the number of delay cells necessary to be utilized in the delay signal generator 420 to generate a delay of t/8. Next, the delay signal generator 420 receives the phase delay equivalent number and the serial digital signal, which is generated by the slicer 340, and delays the serial digital signal by the equivalent number of delay cells, which are the same as those cells utilized in the delay calculator 410 to generate a plurality of delay signals. Following the exemplary example illustrated above, eight delay signals are generated by the delay signal generator 420, and a k^{th} delay signal of the eight delay signals has a time delay equal to k*t/8 with respect to the original serial digital signal, where 0≦k≦7.

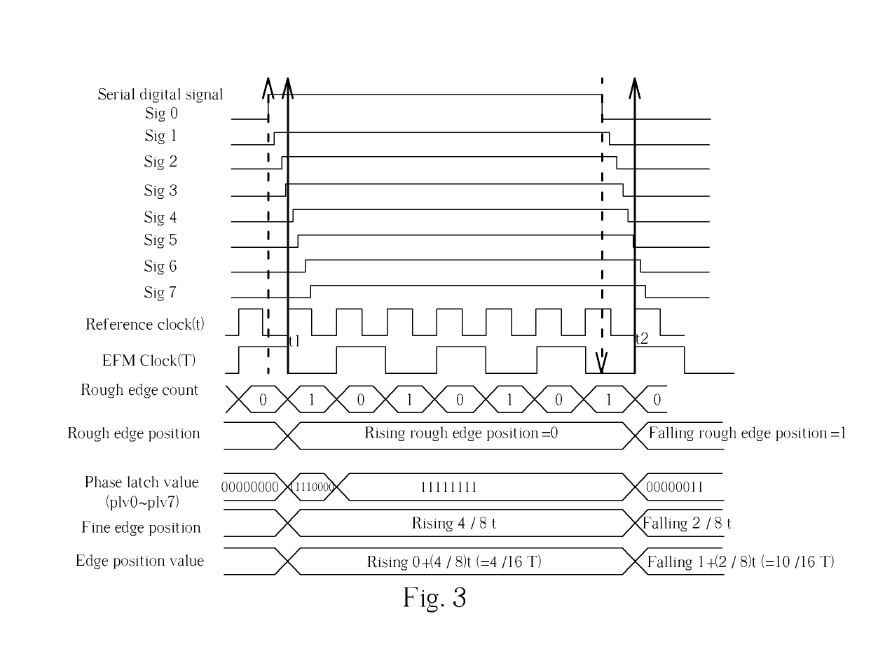

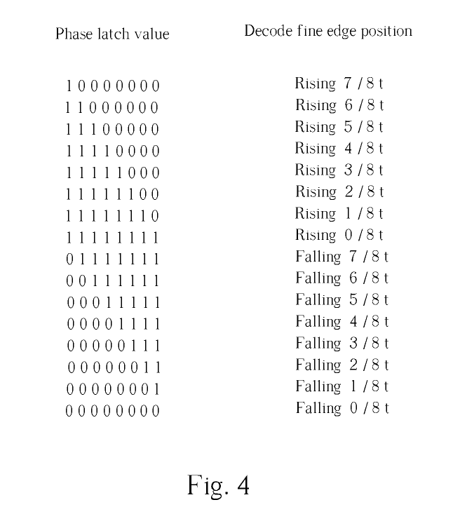

Afterward, an edge detection unit 430 receives the eight delay signals and the reference clock to generate fine edge position values of the corresponding serial digital signal. Please refer to FIG. 3. FIG. 3 illustrates the waveforms of the original serial digital signal, the eight delay signals, and the reference clock. In this embodiment, the reference clock latches the delay signals at the rising edge. At time t1, i.e., around the rising edges of the eight delay signals, the reference clock latches the eight delay signals and a first phase latch value of “11110000” is therefore obtained. At time t2, i.e., around the falling edges of the eight delay signals, the reference clock again latches the eight delay signals and a second phase latch value of “00000011” is therefore obtained. Then the phase latch values are mapped into fine edge position values according to a look-up table shown in FIG. 4. As shown in FIG. 4, the first phase latch value “11110000” corresponds to a decode fine edge position of rising 4t/8; similarly, the second phase latch value “00000011” corresponds to a decode fine edge position of falling 2t/8. Then the edge position integration unit 450 receives the rough edge position value from the rough edge position measuring unit 440 and the fine edge position value from the edge detection unit, and acquires the edge position value for each transition in the serial digital signal. For example, the rising edge position value at time t1 is 4T/16, and the falling edge position value at time t2 is 10T/16, where EFM clock T is half of the reference clock t.

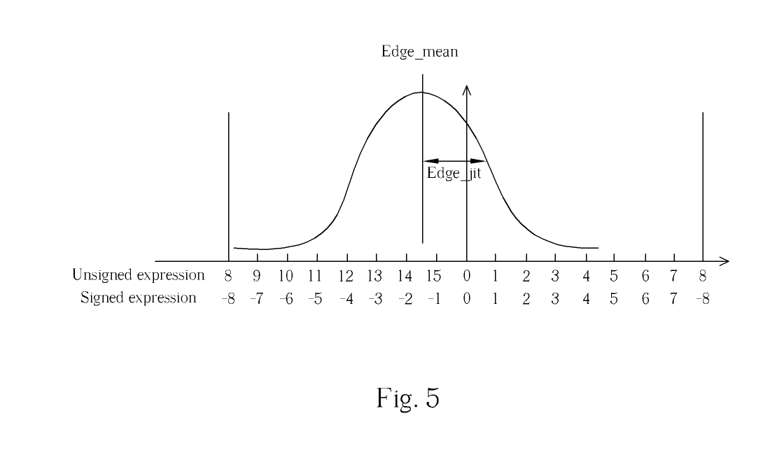

As more serial digital signals generated by the slicer 340 are sent to the DC jitter measuring device 350, the edge detection unit 430 yields more fine edge position values accordingly. The jitter calculation unit 460 collects all the incoming edge position values regardless of the pulse lengths, which the edge position values belong to. Generally speaking, the distribution of the edge position values is of a bell-like shape, as shown in FIG. 5. The position range is from 0T/16 to 15T/16 in unsigned expression. After transformed to signed expression, the position range is from −8T/16 to 7T/16 with 0T/16 in the center. The jitter calculation unit 460 calculates the jitter of the serial digital signal by the following method. First, the jitter calculation unit 460 calculates a first average value Edge_mean of the edge position values. Second, the jitter calculation unit 460 calculates a second average value Edge_jit of the differences between the first average value and the edge position values. Consequently, the second average value is regarded as the jitter of the serial digital signal.

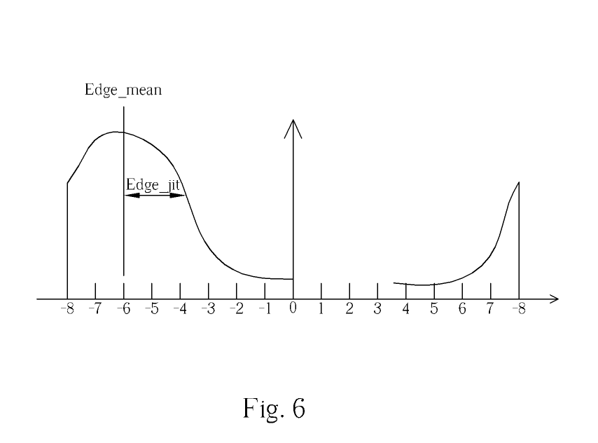

However, in some cases where the latency of the serial digital signal is different from that of the reference clock, as shown in FIG. 6, the center of the distribution of the edge position values is shifted such that the distribution is not like a complete bell-like shape shown in FIG. 6. Therefore, the jitter calculation unit 460 will shift the collected edge position values before calculating the average of the edge position values, causing the distribution of the edge position values to fall in the interval to form a complete bell-like shape. The followings are two embodiments illustrating the mechanism utilized by the jitter calculation unit 460 to shift the edge position values.

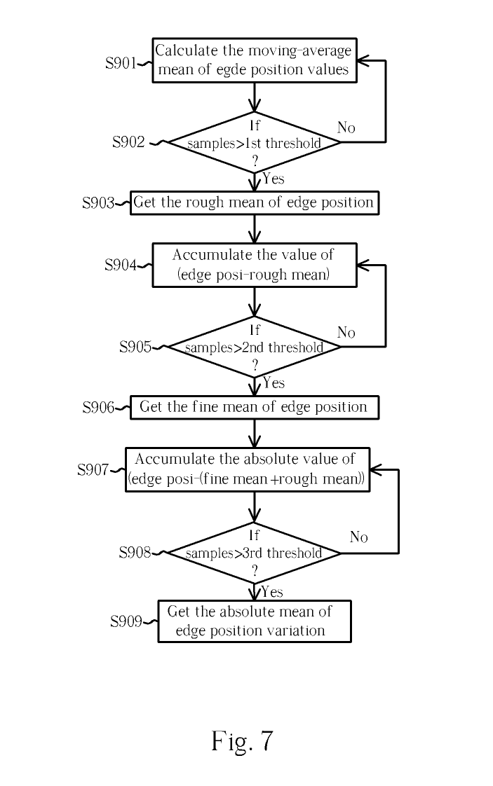

Please refer to FIG. 7. FIG. 7 is the flow chart of the shift mechanism of the first embodiment. The jitter calculation unit 460 calculates a rough mean of the edge position values according to a moving-average method (S901). The formula of the moving-average method is listed below:

$$\begin{matrix}{NEW}_{AVG} = \frac{( W - 1 ) \times {PRE}_{AVG} + {NEW}_{edge}}{W} \\ = {PRE}_{AVG} + \frac{{NEW}_{edge} - {PRE}_{AVG}}{W} ,\end{matrix}$$

where PRE_{AVG} is a former edge mean calculated in the previous step, NEW_{edge} is the present incoming edge position value, 1/W is the weighting of NEW_{edge}, and NEW_{AVG} is a new edge mean. Initially, the PRE_{AVG} is given by an arbitrary value. As more and more incoming edge position values are calculated, the NEW_{AVG} is tending to the rough mean of the edge position values. If the number of the calculated edge position values exceeds a first threshold (S902), the rough mean will be obtained (S903). Next, the jitter calculation unit 460 collects the following incoming edge position values and shifts the edge position values with respect to the rough mean (S904). If the number of the edge position values exceeds a second threshold (S905), the jitter calculation unit 460 calculates the average, i.e., the fine mean, of the edge position values (S906). Then the jitter calculation unit 460 sums the absolute value of the difference between the incoming edge position values and a sum of the rough mean and the fine mean (S907). If the number of the calculated edge position values exceeds a third threshold (S908), an absolute average value is obtained, which is as the DC jitter value (S909).

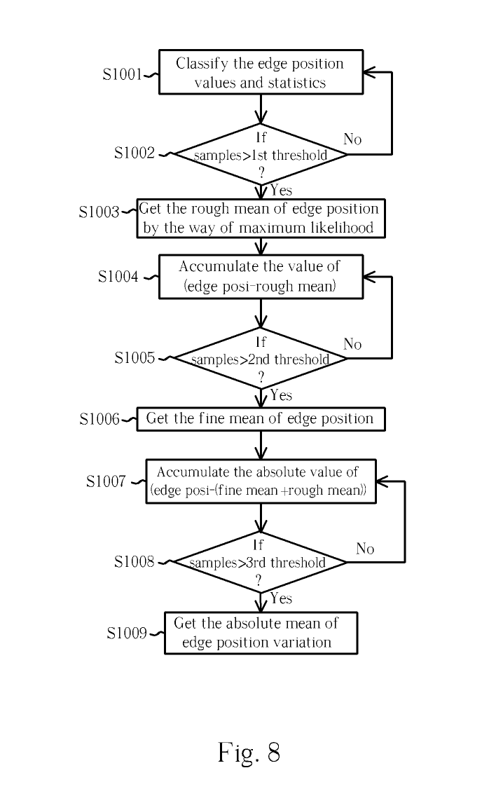

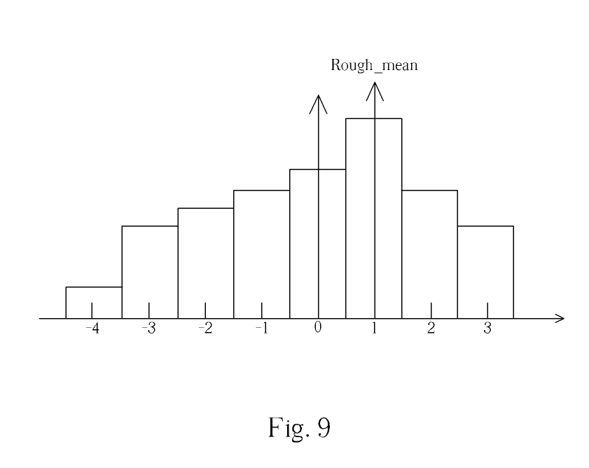

Please refer to FIG. 8. FIG. 8 is the flow chart of the shift mechanism of the second embodiment. Initially, the jitter calculation unit 460 statistically classifies the collected edge position values (S1001), as shown in FIG. 9 for an example. If the number of the calculated edge position values exceeds a first threshold (S1002), the jitter calculation unit 460 finds a most frequently occurring edge position value out of the classified edge position values, and determines the most frequently occurring edge position value as the rough mean indicated by Rough_mean in FIG. 9 (S1003) (The rough mean would be “1” in the example of FIG. 9). Next, the jitter calculation unit 460 collects the following incoming edge position values and shifts the edge position values with respect to the rough mean (S1004). That is, the rough mean is now taken as a reference point and all the following incoming edge position values are re-positioned with respect to the rough mean. If the number of the edge position values exceeds a second threshold (S1005), the jitter calculation unit 460 calculates the average, i.e., the fine mean, of the edge position values (S1006). Then the jitter calculation unit 460 sums the absolute value of the difference between the incoming edge position values and a sum of the rough mean and the fine mean (S1007). If the number of the calculated edge position values exceeds a third threshold (S1008), an absolute average value, i.e., the DC jitter value, is obtained (S1009).

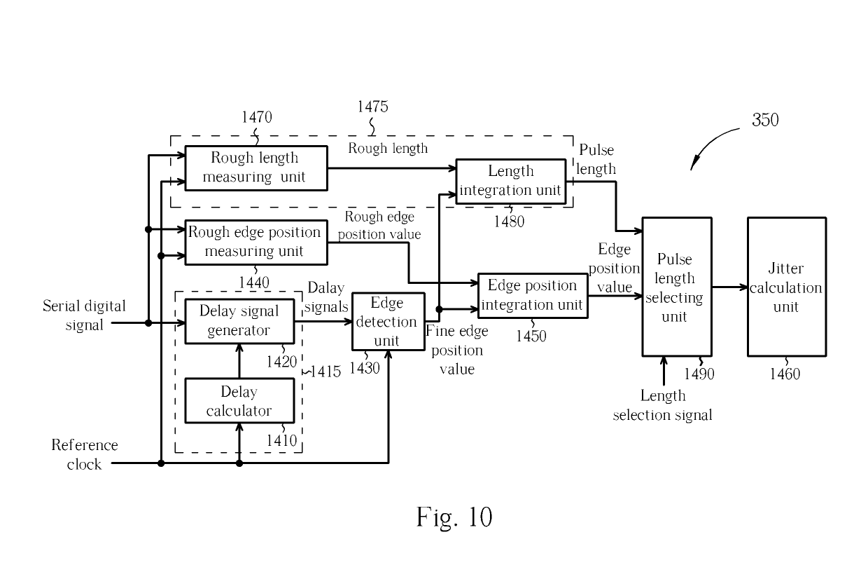

In some cases not all edge position values are concerned about, and those edge position values, which are not important, should not be sent to the jitter calculation unit 460 for the sake of higher calculating efficiency. Please refer to FIG. 10. FIG. 10 shows a block diagram of the DC jitter measuring device 350 according to a second embodiment of the present invention. It includes a signal delay module 1415 having a delay calculator 1410 and a delay signal generator 1420, an edge detection unit 1430, a rough edge position measuring unit 1440, an edge position integration unit 1450, a length measuring unit 1475 having a rough length measuring unit 1470 and a length integration unit 1480, a pulse length selecting unit 1490, and a jitter calculation unit 1460. The rough edge position measuring unit 1440 directly measures the rough edge position value for each transition edge of the serial digital signal according to the reference clock. The delay calculator 1410 receives a reference clock and generates a phase delay equivalent number, which will later be utilized by a delay signal generator 1420, according to a fraction of the period t of the reference clock. For example, if a delay time unit of t/8 is required in the DC jitter measuring device 350, the delay calculator 1410 will generate a phase delay equivalent number that determines the number of delay cells necessary to be utilized in the delay signal generator 1420 to generate a delay of t/8. Next, the delay signal generator 1420 receives the phase delay equivalent number and the serial digital signal, which is generated by the slicer 340, and delays the serial digital signal by the equivalent number of delay cells, which are the same as those cells utilized in the delay calculator 1410, to generate a plurality of delay signals. Following the exemplary example illustrated above, eight delay signals are generated by the delay signal generator 1420, and a k^{th} delay signal of the eight delay signals has a time delay equal to k*t/8 with respect to the original serial digital signal, where 0≦k≦7.

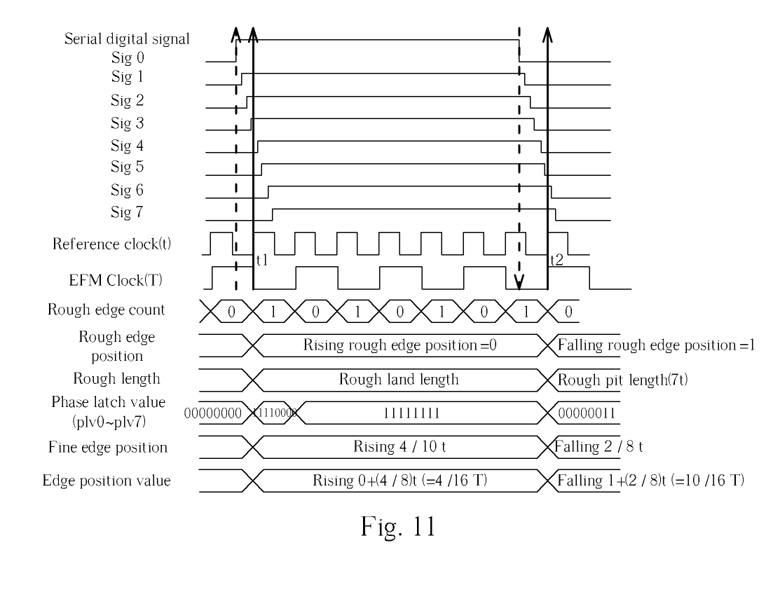

Afterward, an edge detection unit 1430 receives the eight delay signals and the reference clock to generate a fine edge position value of each transition in the corresponding serial digital signal. Please refer to FIG. 11. FIG. 11 illustrates the waveforms of the original serial digital signal, the eight delay signals, and the reference clock. The reference clock latches the delay signals at the rising edge. At time t1, i.e., around the rising edges of the eight delay signals, the reference clock latches the eight delay signals and a first phase latch value of “11110000” is therefore obtained. At time t2, i.e., around the falling edges of the eight delay signals, the reference clock again latches the eight delay signals and a second phase latch value of “00000011” is therefore obtained. Then the phase latch values are mapped into fine edge position values according to a look-up table shown in FIG. 4. As shown in FIG. 4, the first phase latch value “11110000” corresponds to a decode fine edge position of rising 4t/8; similarly, the second phase latch value “00000011” corresponds to a decode fine edge position of falling 2t/8. Then the edge position integration unit 1450 receives the rough edge position value and the fine edge position values, and acquires the edge position value. For example, the rising edge position value at time t1 is 4T/6, and the falling edge position value at time t2 is 10T/6, where EFM clock T is half of the reference clock t.

Moreover, please refer back to FIG. 10, the DC jitter measuring device 350 comprises a rough length measuring unit 1470 for measuring the rough length of the serial digital signal. The rough length measuring unit 1470 receives the serial digital signal and the reference clock, and generates the rough length of the serial digital signal according to the reference clock, as illustrated in FIG. 11. Therefore, a rough length of 7t is obtained in this exemplary example. Subsequently, a length integration unit 1480, which is coupled to the rough length measuring unit 1470 and the edge detection unit 1430, receives the rough length of the serial digital signal and fine edge position values corresponding to the serial digital signal to generate a pulse length, i.e., a more precise length, of the serial digital signal. The accuracy of the pulse length is a delay time unit determined by the delay signal generator 420, i.e., t/8 in this exemplary example. As a result, the pulse length of the serial digital signal of this exemplary example is 7t−4t/8+2t/8.

A pulse length selecting unit 1490 is added by coupling it between the edge position integration unit 1450 and pulse length integration unit 1480 and the jitter calculation unit 1460. The pulse length selecting unit 1490 selects the edge position values, which correspond to a specific pulse length (e.g., 3T) or to more specific pulse lengths (e.g., 3T to 14T), according to one or more length selection signals. As a result, the jitter calculation unit 1460 does not have to calculate all the edge position values generated by the signal edge position, and therefore the calculation efficiency is enhanced.

As more serial digital signals generated by the slicer 340 shown in FIG. 1 are sent to the DC jitter measuring device 350, the edge detection unit 1430 yields more fine edge position values accordingly. The jitter calculation unit 1460 collects all the incoming edge position values selected by pulse length selecting unit 1490. Generally speaking, the distribution of the edge position values is of a bell-like shape, as shown in FIG. 5. The position range is from 0T/16 to 15T/16 in unsigned expression. After transformed to signed expression, the position range is from −8T/16 to 7T/16 with 0T/16 in the center. The jitter calculation unit 1460 calculates the jitter of the serial digital signal by the following method. First, the jitter calculation unit 1460 calculates a first average value of the edge position values. Second, the jitter calculation unit 1460 calculates a second average value of the differences between the first average value and the edge position values. Consequently, the second average value is regarded as the jitter of the serial digital signal.

Please refer to FIG. 7. FIG. 7 is the flow chart of the shift mechanism of the first embodiment. The jitter calculation unit 1460 calculates a rough mean of the edge position values according to a moving-average method (S901). The formula of the moving-average method is listed below:

$$\begin{matrix}{NEW}_{AVG} = \frac{( W - 1 ) \times {PRE}_{AVG} + {NEW}_{edge}}{W} \\ = {PRE}_{AVG} + \frac{{NEW}_{edge} - {PRE}_{AVG}}{W} ,\end{matrix}$$

where PRE_{AVG} is a former edge mean calculated in the previous step, NEW_{edge} is the present incoming edge position value, 1/W is the weighting of NEW_{edge}, and NEW_{AVG} is a new edge mean. Initially, the PRE_{AVG} is given by an arbitrary value. As more and more incoming edge position values are calculated, the NEW_{AVG} is tending to the rough mean of the edge position values. If the number of the calculated edge position values exceeds a first threshold (S902), the rough mean will be obtained (S903). Next, the jitter calculation unit 1460 collects the following incoming edge position values and shifts the edge position values with respect to the rough mean (S904). If the number of the edge position values exceeds a second threshold (S905), the jitter calculation unit 1460 calculates the average, i.e., the fine mean, of the edge position values (S906). Then the jitter calculation unit 1460 sums the absolute value of the difference between the incoming edge position values and a sum of the rough mean and the fine mean (S907). If the number of the calculated edge position values exceeds a third threshold (S908), an absolute average value is obtained, which is as the DC jitter value (S909).

In summary, a jitter measuring method and its corresponding device is disclosed. According to this method, all edge position values can be sent to the jitter calculation unit to calculate the jitter; moreover, in some cases the jitter calculation unit can only calculate some specific edge position values corresponding to one or more specific pulse length(s) such that the calculation efficiency of the jitter calculation unit is improved greatly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A jitter measuring device for measuring a jitter of a serial digital signal, the jitter measuring device comprising:
an edge position measuring unit for receiving the serial digital signal and a reference clock and measuring an edge position for each transition of the serial digital signal according to the reference clock;
a jitter calculation unit coupled to the edge detection unit for:
calculating a first average value of a plurality of edge position values; and
determining the jitter of the serial digital signal by calculating an average value of differences between the first average value and the edge position values.

2. The jitter measuring device of claim 1, wherein the edge position measuring unit further comprises:
a rough edge position measuring unit for receiving the serial digital signal and the reference clock and generating a rough edge position value for each transition edge of the serial digital signal;
a signal delay module, for receiving the serial digital signal and the reference clock having a period of t, and delaying the serial digital signal to generate a set of N delay signals, wherein a k^{th} delay signal of the N delay signals has a delay time k*t/N with respect to the serial digital signal;
an edge detection unit coupled to the signal delay module, for generating an fine edge position value according to the set of N delay signals and the reference clock; and
an edge position integration unit coupled to the rough edge position measuring unit and the edge detection unit for receiving the rough edge position value and the fine edge position value, and calculating the pulse edge position value for each transition of the serial digital signal.

3. The jitter measuring device of claim 2, wherein the signal delay module comprises:
a delay calculator, coupled to the reference clock, for generating a phase delay equivalent number according to the reference clock; and
a delay signal generator, coupled to the delay calculator and the serial digital signal, for generating the set of N delay signals according to the phase delay equivalent number and the serial digital signal.

4. The jitter measuring device of claim 1, wherein the jitter calculation unit further calculates a second average value of the edge position values using moving-average method, shifts the edge position values with respect to the second average value to generate shifted edge position values, and averages the shifted edge position values to determine the first average value.

5. The jitter measuring device of claim 1, wherein the jitter calculation unit further statistically classifies the edge position values, selects a most frequently occurring edge position value out of the classified edge position values to be a second average value, shifts the edge position values with respect to the second average value to generate shifted edge position values, and averages the shifted edge position values to determine the first average value.

6. The jitter measuring device of claim 1 further comprising:
a length measuring unit, coupled to the edge detection unit, for measuring a pulse length of the serial digital signal according to the serial digital signal, the reference clock, and the edge position values, and outputting the pulse length; and
a pulse length selecting unit, coupled to the edge detection unit, the length measuring unit, and the jitter calculation unit, for receiving a length selection signal and selecting a plurality of edge position values of a specific pulse length according to the length selection signal to be sent to the jitter calculation unit.

7. The jitter measuring device of claim 6, wherein the length measuring unit comprises:
a rough length measuring unit, for receiving the serial digital signal and the reference clock, and generating a rough length of the serial digital signal; and
a length integration unit, coupled to the rough length measuring unit, for determining the pulse length of the serial digital signal according to the rough length and edge position values of the specific pulse length.

8. The jitter measuring device of claim 1, wherein the serial digital signal is read from an optical disc.

9. A method for measuring a jitter of a serial digital signal, the method comprising:
measuring an edge position according a reference clock for each transition of the serial digital signal;
calculating a first average value of a plurality of edge position values; and
determining the jitter of the serial digital signal by calculating an average value of differences between the first average value and the edge position values.

10. The method of claim 9, wherein measuring the edge position comprises:
measuring a rough edge position for each transition of the serial digital signal according to the reference clock;
generating a set of N delay signals by delaying the serial digital signal according to a reference clock having a period of t, wherein a k^{th} delay signal of the N delay signals has a delay time k*t/N with respect to the serial digital signal;
generating a fine edge position value according to the set of N delay signals and the reference clock;
combining the rough edge position value and the fine edge position value, and calculating the pulse edge position value for each transition of the serial digital signal.

11. The method of claim 10, wherein generating the set of N delay signals comprises:
generating a phase delay equivalent number according to the reference clock; and
generating the set of N delay signals according to the phase delay equivalent number and the serial digital signal.

12. The method of claim 9 further comprising:
calculating a second average value of the edge position values using moving-average method;
shifting the edge position values with respect to the second average value to generate shifted edge position values; and
averaging the shifted edge position values to determine the first average value.

13. The method of claim 9 further comprising:
statistically classifying the edge position values;
selecting a most frequently occurring edge position value out of the classified edge position values to be a second average value;
shifting the edge position values with respect to the second average value to generate shifted edge position values; and
averaging the shifted edge position values to determine the first average value.

14. The method of claim 9 further comprising:
measuring and outputting a pulse length of the serial digital signal according to the serial digital signal, the reference clock, and the edge position values; and
selecting a plurality of edge position values of a specific pulse length according to a length selection signal to be processed while determining the jitter of the serial digital signal.

15. The method of claim 14, wherein measuring the pulse length of the serial digital signal comprises:
generating a rough length of the serial digital signal according to the serial digital signal and the reference clock; and
determining the pulse length of the serial digital signal according to the rough length and edge position values of the specific pulse length.

16. The method of claim 9, wherein the serial digital signal is read from an optical disc.
